(19) United States
(12) Patent Application Publication
(10) Pub. No.: US 2024/0196939 A1
(43) Pub. Date: Jun. 20, 2024

(54) COOKING RECIPE DISPLAY SYSTEM, COOKING RECIPE DISPLAY DEVICE, COOKING RECIPE DISPLAY METHOD, AND PROGRAM

(71) Applicant: Panasonic Intellectual Property Management Co., Ltd., Osaka (JP)

(72) Inventors: HIROKI YAMADA, Shiga (JP); YASUHIRO YUKI, Kanagawa (JP); MASAFUMI SADAHIRA, Shiga (JP)

(21) Appl. No.: 18/555,107

(22) PCT Filed: Apr. 11, 2022
(86) PCT No.: PCT/JP2022/017526

§ 371 Date: Oct. 12, 2023

(30) Foreign Application Priority Data
Apr. 22, 2021 (JP) 2021-072300

(51) Int. Cl. A23L 5/10; G06F 16/383; G06Q 50/10

(52) U.S. Cl. CPC A23L 5/10; G06F 16/383; G06Q 50/10

(57) ABSTRACT

A cooking-recipe display system according to the present disclosure includes a cooking recipe DB, an assistance information DB, a characteristics-detector, an extractor, and an outputter. The cooking recipe DB holds a plurality of cooking recipes. The assistance information DB holds selection-assisting information for assisting in selecting a cooking recipe from among the plurality of cooking recipes. The characteristics-detector detects characteristics of the cooking recipe from a natural language sentence contained in the cooking recipe, with the cooking recipe being each of a plurality of target recipes. The extractor refers to the assistance information DB based on the characteristics of the cooking recipe in the plurality of target recipes to extract the selection-assisting information from the plurality of target recipes. The outputter outputs the selection-assisting information regarding the plurality of target recipes, the selection-assisting information being extracted by the extractor.

### TECHNICAL FIELD

The present invention relates to cooking-recipe display systems.

### BACKGROUND ART

In recent years, display systems for displaying cooking recipes have been known. Patent Literature 1 discloses a menu retrieval device that displays target calorie-intake values together with dish names. Patent Literature 2 discloses an electronic menu-creation device that determines whether or not the dish selected by a user can be cooked on the basis of information about cooking utensils in possession of the user.

### CITATION LIST

### Patent Literature

PTL 1: Japanese Patent Unexamined Publication No. 2004-110697
PTL 2: Japanese Patent Unexamined Publication No. H09-6751

### SUMMARY OF THE INVENTION

In the conventional technologies described above, however, no effective information in selecting by a user a cooking recipe has been presented, so that it is difficult to sufficiently assist for the user to select a cooking recipe.

The present disclosure provides a cooking-recipe display system, cooking-recipe display device, cooking-recipe display method, and program which are all capable of assisting in selecting cooking recipes.

An aspect of the present disclosure is a cooking-recipe display system configured to output a plurality of target recipes each of which is a cooking recipe among a plurality of cooking recipes. The cooking-recipe display system includes a cooking recipe database, an assistance information database, a detector, an extractor, and an outputter.

The cooking recipe database holds the plurality of cooking recipes. The assistance information database holds selection-assisting information for assisting in selecting a cooking recipe from among the plurality of cooking recipes. The detector is configured to detect characteristics of the cooking recipe from a natural language sentence contained in the cooking recipe, the cooking recipe being each of the plurality of target recipes.

The extractor is configured to refer to the assistance information database based on the characteristics of the cooking recipe in the plurality of target recipes to extract the selection-assisting information from the plurality of target recipes. The outputter is configured to output the selection-assisting information regarding the plurality of target recipes, the selection-assisting information being extracted by the extractor.

In accordance with the present disclosure, it is possible to assist in selecting cooking recipes.

### BRIEF DESCRIPTION OF DRAWINGS

FIG. 1 is a schematic diagram illustrating a configuration of a cooking-recipe display system according to an embodiment.

FIG. 2 is a block diagram illustrating a functional configuration of the cooking-recipe display system according to the embodiment.

FIG. 3 is a diagram illustrating one example of an ingredient table.

FIG. 4 is a diagram illustrating one example of a procedure table.

FIG. 5 is a diagram illustrating the result of analysis of a target recipe.

FIG. 6 is a diagram illustrating one example of an assistance information database.

FIG. 7 is a diagram illustrating a first example of a recipe-selection image.

FIG. 8 is a diagram illustrating a second example of the recipe-selection image.

FIG. 9 is a diagram illustrating a third example of the recipe-selection image.

FIG. 10 is a diagram illustrating a first example of selection-assisting information.

FIG. 11 is a diagram illustrating a second example of the selection-assisting information.

FIG. 12 is a diagram illustrating a third example of the selection-assisting information.

FIG. 13 is a diagram illustrating a fourth example of the selection-assisting information.

FIG. 14 is a diagram illustrating a fourth example of the recipe-selection image.

FIG. 15 is a diagram illustrating a fifth example of the recipe-selection image.

### DESCRIPTION OF EMBODIMENTS

Exemplary embodiments according to the present disclosure will be specifically described with reference to the accompanying drawings. In the drawings, the same or substantially same constituent elements are designated with the same numerals and symbols, and their duplicate explanations will be omitted or simplified.

### [Outlines]

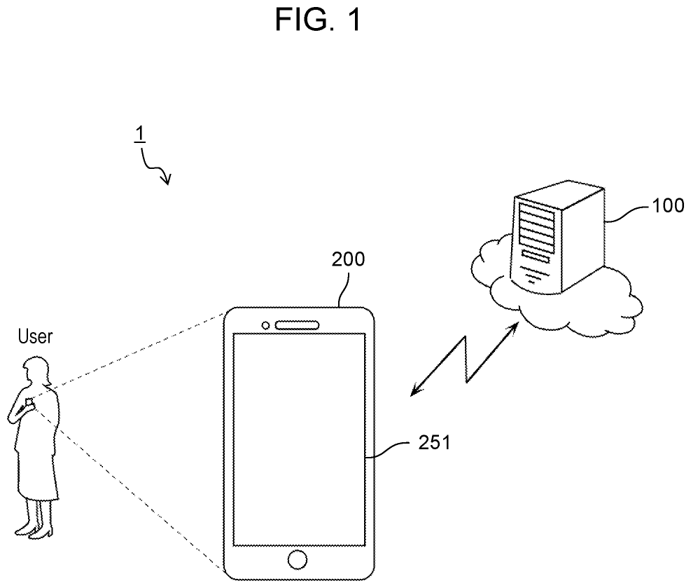

Outlines of cooking-recipe display system 1 according to an exemplary embodiment are described with reference to FIG. 1. FIG. 1 is a schematic diagram illustrating a configuration of cooking-recipe display system 1 according to the embodiment.

As shown in FIG. 1, cooking-recipe display system 1 according to the embodiment includes server device 100 and information-processing terminal 200. Server device 100 is a web server. Server device 100 and information-processing terminal 200 are communicatively coupled to each other via a network such as the Internet.

Server device 100 provides cooking recipes. Server device 100 may be any of a cloud server and a physical server. Server device 100 not only provides cooking recipes but also either one or both of generates and manages cooking recipes.

Information-processing terminal 200 is an information-processing device having display screen 251. Information-processing terminal 200 is, for example, a portable information-processing device, such as, a smartphone, tablet terminal, or notebook personal computer.

Information-processing terminal 200 may also be a stationary information-processing device such as a desktop personal computer, smart display, or signage.

In the embodiment, as shown in FIG. 1, information-processing terminal 200 is a smartphone that includes display screen 251 provided with both a display function and a manipulation function. In the embodiment, information-processing terminal 200 corresponds to a recipe display device.

Information-processing terminal 200 has a network connection function. Therefore, a user can manipulate information-processing terminal 200 to access server device 100, thereby retrieving cooking recipes. Then, among from a plurality of the retrieved cooking recipes, the user can select a cooking recipe to be cooked. The selected cooking recipe (i.e., specifically, cooking procedures and necessary ingredients) is displayed on display screen 251 of information-processing terminal 200, thereby being presented to the user.

### [Functional Configuration]

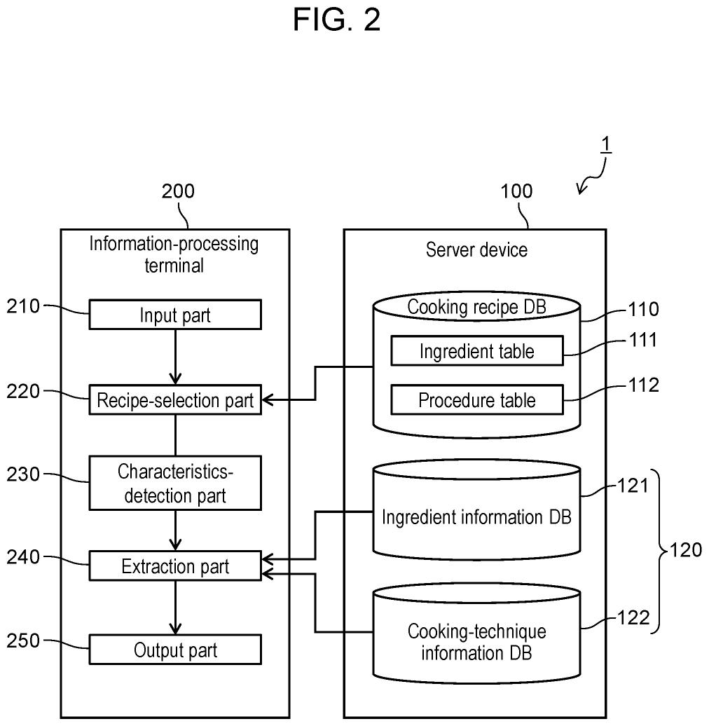

A functional configuration of cooking-recipe display system 1 according to the embodiment is specifically described with reference to FIG. 2. FIG. 2 is a block diagram illustrating the functional configuration of cooking-recipe display system 1 according to the embodiment.

Server device 100 manages a plurality of databases regarding offers of cooking recipes. Specifically, as shown in FIG. 2, server device 100 manages both cooking recipe database 110 (hereinafter, the database is sometimes abbreviated as “DB”) and assistance information DB 120. Server device 100 includes storage devices such as an HDD (hard disk drive) and an SSD (solid state drive), and thereby stores cooking recipe DB 110 and assistance information DB 120.

Cooking recipe DB 110 holds a plurality of cooking recipes each of which contains natural language sentences. Each of the cooking recipes includes both an ingredient list containing one or more ingredients to be used for a dish, and one or more procedures (cooking procedures) indicating how to cook. The ingredient list and procedures contain recipe terms expressed in natural language sentences. As shown in FIG. 2, cooking recipe DB 110 includes ingredient table 111 and procedure table 112.

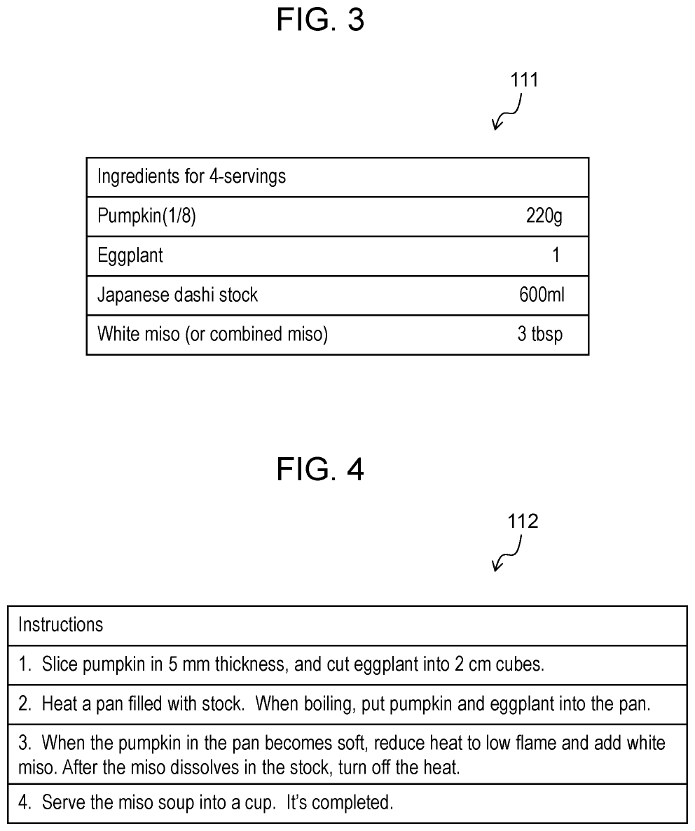

Ingredient table 111 holds the ingredient list of each cooking recipe. FIG. 3 shows one example of ingredient table 111. The ingredient list held in ingredient table 111 contains one or more ingredients used for a dish (e.g., “Miso Soup with Pumpkin and Eggplant”) and the quantity of each of the ingredients. The quantity of each ingredient is set based on the quantity of the dish (for the number of servings).

The ingredient list is displayed on display screen 251 in the case where a user selects “Miso Soup with Pumpkin and Eggplant.” Ingredient table 111 may contain information indicating either one or both of calories and a salt content of the dish.

Referring back to FIG. 2, procedure table 112 holds procedure information that indicates one or more cooking procedures of each cooking recipe. FIG. 4 shows one example of procedure table 112. FIG. 4 indicates four cooking procedures for cooking “Miso Soup with Pumpkin and Eggplant” shown in FIG. 3.

The four cooking procedures are displayed on display screen 251 in the case where a user selects “Miso Soup with Pumpkin and Eggplant.” The four cooking procedures may be displayed one by one or, alternatively, all in one screen. The cooking procedures and ingredient list may be displayed separately or, alternatively, simultaneously.

Referring back to FIG. 2, assistance information DB 120 is a database that holds a plurality of pieces of selection-assisting information. The plurality of pieces of the selection-assisting information is information that assists in selecting a cooking recipe and is regarding the ingredients or cooking techniques of the cooking recipe. As shown in FIG. 2, assistance information DB 120 includes ingredient information DB 121 and cooking-technique information DB 122.

Ingredient information DB 121 is a database that holds one or more pieces of ingredient information. The ingredient information is one example of the selection-assisting information regarding the ingredients of a cooking recipe. The ingredient information contains information that indicates the characteristics of ingredients such as the number, kinds, rarity, etc. of ingredients, for example. The rarity is an index indicating the degree of difficulty in obtaining an ingredient.

“Ingredients” include not only food materials such as meat and vegetables but also seasonings, water, etc. “Ingredients” are basically materials edible or drinkable for a human being but, besides edible ones, may include inedible materials to be used for enhancing appearance of dishes.

Cooking-technique information DB 122 is a database that holds one or more pieces of cooking technique information. The cooking technique information is one example of the selection-assisting information regarding the cooking techniques of a cooking recipe. The cooking technique information includes the information indicating the characteristics of cooking which include the number of cooking actions and cooking time of the cooking such as cutting, baking, and simmering, for example.

Server device 100 receives a request from information-processing terminal 200, and then transmits, back to information-processing terminal 200, the ingredient list, cooking procedures, selection-assisting information, etc. of a cooking recipe in response to the request.

As shown in FIG. 2, information-processing terminal 200 includes input part 210, recipe-selection part 220, characteristics-detector 230, extractor 240, and outputter 250.

In the embodiment, input part 210 and outputter 250 are configured as one touch panel that corresponds to display screen 251 shown in FIG. 1. Display screen 251 displays a GUI (graphical user interface) suitable for user's touch manipulations, and the like. Display screen 251 is, for example, a liquid crystal display device, an organic EL (electro luminescence) display device, or the like.

Input part 210 may also be a voice input device such as a microphone. Outputter 250 may also be a voice output device such as a speaker. Input part 210 and outputter 250 may also be configured as separate devices from each other. In the embodiment, outputter 250 is a display device or a voice output device. Input part 210 includes a variety of input devices such as a sensing device, voice input device, mouse, keyboard, etc.

Recipe-selection part 220, characteristics-detector 230, and extractor 240 are each composed of either one or more dedicated control circuits or one or more general-purpose control circuits that execute their designated functions. The control circuits include a memory for storing programs such as application programs, a processor for executing the stored programs, various input-output ports, and the like.

The processor executes the programs stored in the memory, thereby performing various functions of control. The processor is composed of, for example, an MPU (micro processing unit), a CPU (central processing unit), a DSP (digital signal processor), a GPU (graphical processing unit), an SoC (system on a chip), and the like.

Input part 210 receives, from a user, an input of a search term associated with dishes. Input part 210 receives the user's manipulation via the GUI displayed on display screen 251 in relation to search and selection of cooking recipes.

Recipe-selection part 220 refers to cooking recipe DB 110 based on the search term. Thereby, recipe-selection part 220 selects at least two cooking recipes as a plurality of target recipes associated with the search term having been received by input part 210. Each of the plurality of target recipes is a cooking recipe displayed on display screen 251.

Specifically, each of the target recipes is a cooking recipe obtained resulting from the search, so that the cooking recipe may possibly be chosen by the user. In the embodiment, recipe-selection part 220 corresponding to a selection part.

The search terms include, such as, the names of dishes, ingredients, cooking utensils, etc. Recipe-selection part 220 searches for a plurality of cooking recipes that contain the search terms having been received by input part 210, from among the plurality of cooking recipes held in cooking recipe DB 110. Recipe-selection part 220 selects a cooking recipe applicable to the search target, as a target recipe. In most cases, a plurality of target recipes is retrieved through a search; however, only one target recipe may hit.

Characteristics-detector 230 is a detecting part that detects the characteristics of each of the plurality of target recipes from the natural language sentences contained in these target recipes.

Specifically, as the characteristics of each of the plurality of target recipes, characteristics-detector 230 detects terms associated with one item selected from the following information group. The information group contains either one or both of the number and kinds of ingredients to be used, either one or both of the number and kinds of cooking actions, the number of cooking procedures, cooking time, and either one or both of the number and kinds of cooking utensils to be used.

Specifically, characteristics-detector 230 analyzes natural language sentences that express the ingredient list and cooking procedures of the target recipe. Characteristics-detector 230 refers to ingredient table 111 of cooking recipe DB 110, thereby acquiring the number and kinds of ingredients contained in the ingredient list of the target recipe.

Based on the kinds of ingredients, for example, characteristics-detector 230 refers to the table of rarity in which rarity is associated with each ingredient, thereby determining the rarity of each of the ingredients. The table of rarity (not shown) is held in server device 100 or information-processing terminal 200, for example.

Characteristics-detector 230 may determine, besides the rarity, either one or both of nutrients and storage periods, or any other term of the ingredients. For performing the determination, a table in which either one or both of nutrients and storage periods are associated with the kinds of ingredient may be held in server device 100 or information-processing terminal 200. The table (e.g., table of rarity) which shows the characteristics relating to ingredients to be taken into consideration for the determination, may be contained in ingredient table 111.

Characteristics-detector 230 refers to procedure table 112 of cooking recipe DB 110, thereby analyzing natural language sentences that express the cooking procedures of the target recipe. Thus, characteristics-detector 230 acquires the number and kinds of cooking actions to be performed in cooking the target recipe, the number of cooking procedures, the cooking time, the number and kinds of cooking utensils to be used, and any other item.

For example, characteristics-detector 230 extracts terms associated with the cooking actions from the natural language sentences expressing the cooking procedures. Characteristics-detector 230 refers to, for example, a term list that contains a plurality of terms that would be extracted, thereby extracting the terms in question that are the same as or synonymous with the terms listed in the term list. The term list (not shown) is held in server device 100 or information-processing terminal 200.

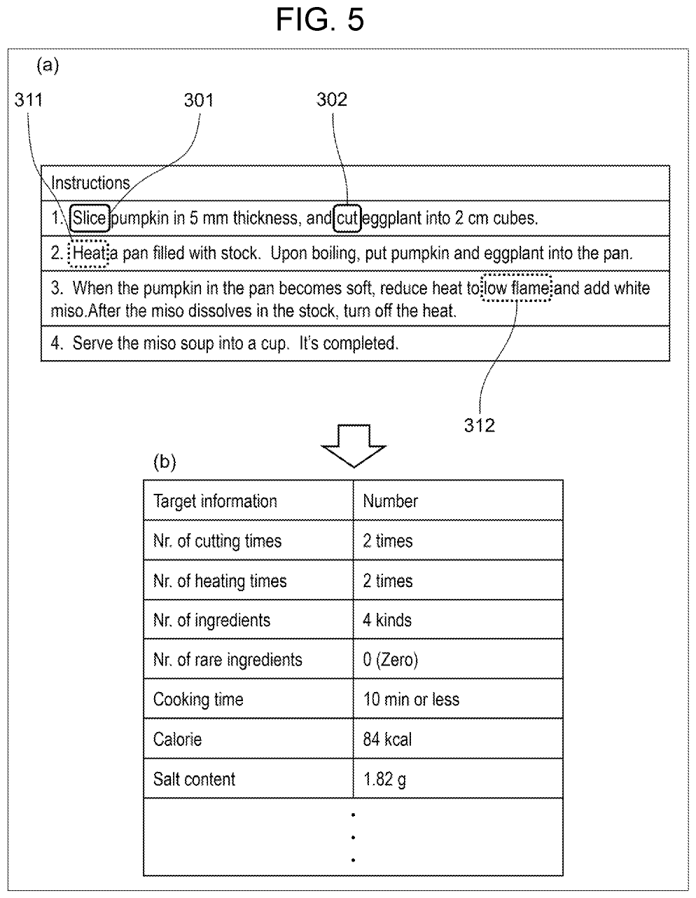

FIG. 5 shows the result of analysis of the target recipe. For example, as shown in (a) of FIG. 5, characteristics-detector 230 detects two terms, “slice” and “cut,” which are indicated by solid-line frames 301 and 302, respectively, from the first cooking procedure. These terms are words relating to actions of cutting ingredients among the cooking actions.

Characteristics-detector 230 detects two terms, “heating” indicated by short-dashed line frame 311 from the second cooking procedure and “low flame” indicated by short-dashed line frame 312 from the third cooking procedure. These terms are words relating to actions of heating ingredients among the cooking actions.

In (b) of FIG. 5 is shown the result of analysis of the target recipe. The number of times of cutting and the number of times of heating, indicate the numbers of the terms expressing the respective cooking actions, cutting and heating, which are obtained based on the extraction result shown in (a) of FIG. 5. In (b) of FIG. 5, “Nr. of Ingredients” indicates the total number of ingredients contained in the target recipe. “Nr. of Rare Ingredients” indicates the number of ingredients of higher rarity among the ingredients contained in the target recipe. “Nr. of Ingredients” and “Nr. of Rare Ingredients” are resulted from the analysis of the ingredient list.

“Cooking Time” indicates the time required for cooking the dish of the target recipe. “Calorie” indicates the calorie contained in the dish of the target recipe. “Salt Content” indicates the amount of salt contained in the dish of the target recipe. “Cooking Time,” “Calorie,” and “Salt Content” are resulted from the analysis of the target recipe.

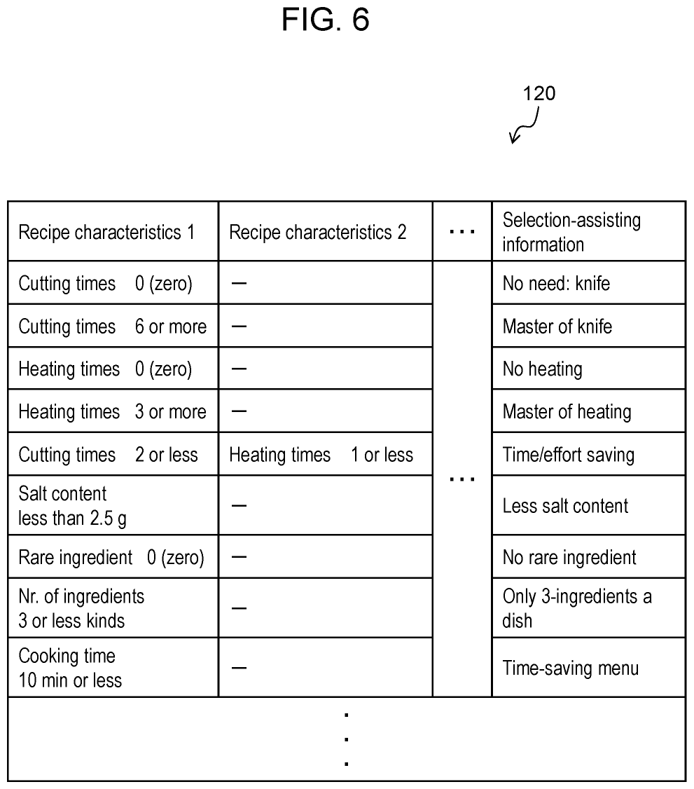

Based on the characteristics detected by characteristics-detector 230, extractor 240 refers to assistance information DB 120, thereby extracting selection-assisting information for each of the target recipes. FIG. 6 shows one example of assistance information DB 120. As shown in FIG. 6, assistance information DB 120 is such that selection-assisting information is associated with either one recipe characteristic contained in the target recipe or a combination of a plurality of recipe characteristics contained in the target recipe.

The recipe characteristics are the characteristics of either ingredients contained in the cooking recipe or cooking techniques contained in the cooking recipe. Correspondence relationships between the characteristics of ingredients and the selection-assisting information (e.g., data regarding “Rare ingredient: 0 [zero]”), correspond to ingredient information DB 121. Correspondence relationships between the characteristics of cooking techniques and the selection-assisting information (e.g., items such as “Nr. of Cutting Times: 0 [zero]”), correspond to cooking-technique information DB 122. The selection-assisting information may be associated with a combination of the characteristics of ingredients and the characteristics of cooking techniques.

Extractor 240 refers to assistance information DB 120, thereby extracting selection-assisting information corresponding to the recipe characteristics contained in the target recipe. In the case where the target recipe contains a plurality of recipe characteristics, extractor 240 may extract a plurality of pieces of selection-assisting information.

For example, in the case of the result of analysis shown in FIG. 5, two pieces of selection-assisting information, i.e., “No Rare Ingredient” and “Time-Saving Menu,” are extracted which satisfy the two conditions, i.e., “Nr. of Rare Ingredient: 0 (zero)” and “Cooking Time: 10 min or less.”

Outputter 250 outputs the selection-assisting information extracted by extractor 240 for each of the plurality of target recipes. That is, display screen 251 being outputter 250 displays the selection-assisting information. Outputter 250 displays, for each target recipe, both recipe-displaying information selectable by the user and the selection-assisting information next to each other.

The recipe-displaying information contains, for example, either one or both of the name and image of the target recipe. That is, in order to assist the user in selecting the cooking recipe to be cooked, the selection-assisting information is displayed on display screen 251 simultaneously with the recipe-displaying information expressing the cooking recipes.

In the embodiment, a plurality of selection candidates of cooking recipes and the selection-assisting information for each candidate are displayed next to each other on display screen 251. This allows the user to compare the plurality of cooking recipes while viewing the selection-assisting information for each cooking recipe.

### [Specific Examples of Display]

Specific examples of the recipe-selection image displayed on display screen 251 in cooking-recipe display system 1 according to the embodiment will be described.

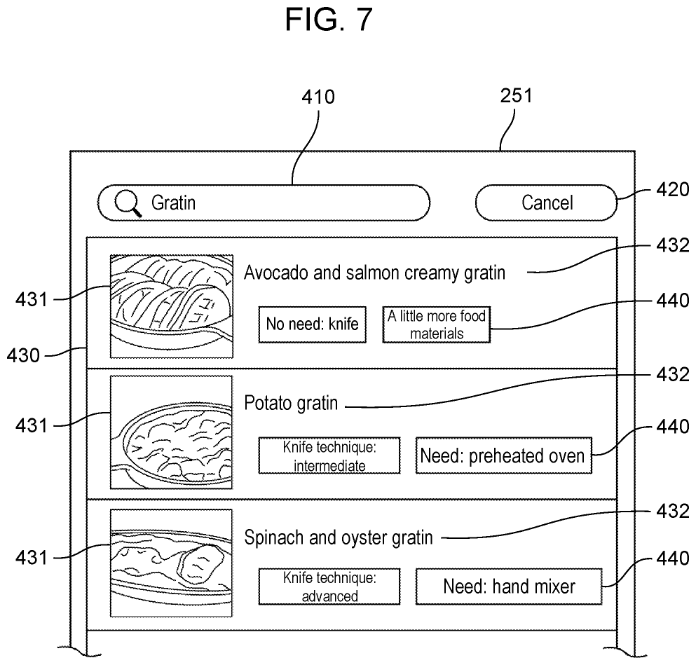

FIG. 7 shows a first example of a recipe-selection image. As shown in FIG. 7, the recipe-selection image contains search window 410, cancel button 420, and recipe-selection list 430.

Search window 410 receives text, as a search term, such as words (e.g., ingredient, dish name, etc.) relating to a cooking recipe.

Cancel button 420 is a button for canceling the search for cooking recipes.

Recipe-selection list 430 contains the result of the search based on the search term that has been entered in search window 410. Specifically, in recipe-selection list 430, a plurality of target recipes having been determined by recipe-selection part 220 is arranged together in a column. In the example shown in FIG. 7, as the result of the search based on the search term “gratin,” cooking recipes whose dishes have names containing “gratin” are displayed.

Recipe-selection list 430 contains both dish image 431 and dish name 432 for each target recipe. Dish image 431 is an image, for example, taken by photographing a finished dish of the target recipe. Dish name 432 is the name of dish of the target recipe.

Both dish image 431 and dish name 432 are an example of the recipe-displaying information selectable by the user. Upon selection of any of dish image 431 and dish name 432, either the ingredient list or cooking procedure of the target recipe are displayed on display screen 251.

“Selection” by the user is performed through a predetermined manipulation such as tapping (single-clicking), double-clicking, long-pressing, or sliding a button, for example.

The manipulation of tapping (single-clicking) a button is to touch the displayed button image once with a finger. Double-clicking a button is to touch the displayed button image twice with a finger in succession. Long-pressing a button is to continue to touch, e.g., for more than one second, the displayed button image with a finger. Sliding a button is to slide a finger on the displayed button image, with the finger being in contact with the displayed button image.

The manipulation is received by input part 210 and then a corresponding image is displayed on display screen 251.

A plurality of different manipulations may be performed on one button, so that different screens are displayed on display screen 251. For example, for dish image 431 or dish name 432, the content of a pop-up image displayed may be different depending on which one of tapping and long-pressing is performed.

For example, in the case where tapping is made on dish image 431 or dish name 432, an ingredient list of the target recipe may be displayed. In the case where long-pressing is made on dish image 431 or dish name 432, a cooking procedure of the target recipe may be displayed.

Recipe-selection list 430 contains selection-assisting information 440 extracted by extractor 240. Selection-assisting information 440 is label information that contains natural language sentences indicated by selection-assisting information (see FIG. 6) of assistance information DB 120.

For example, for the cooking recipe “Avocado and Salmon Creamy Gratin,” dish name 432 and selection-assisting information 440, “No Need: Knife” and “A Little More Food Materials,” are displayed together side by side. For the target recipe “Potato Gratin,” dish name 432 and selection-assisting information 440, “Knife Technique: Intermediate” and “Need: Preheated Oven,” are displayed together side by side. In the example shown in FIG. 7, the cooking techniques are “No Need: Knife,” “Knife Technique: Intermediate,” and “Knife Technique: Advanced.”

In this way, the user can select the dish to be cooked while referring to selection-assisting information regarding the cooking techniques being displayed for each target recipe. In situations where the user is not good at using a knife, where its troublesome to use a knife, or where no oven is available at home, the user may avoid selecting the cooking recipe “Potato Gratin.” In this case, the user may select the cooking recipe “Avocado and Salmon Creamy Gratin.”

That is, the user can select the cooking recipe only by viewing the selection image of the cooking recipe, without need for checking specific ingredients and specific cooking procedures of the cooking recipe.

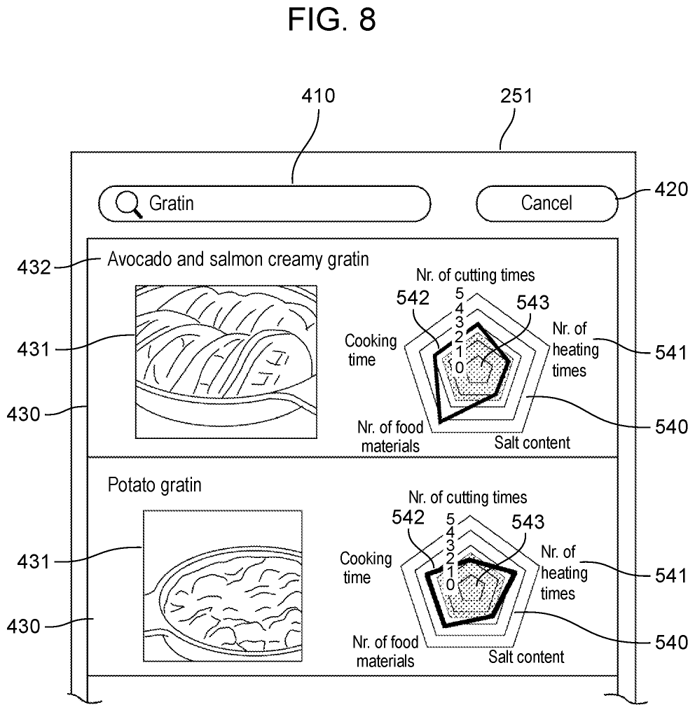

FIG. 8 shows a second example of the recipe-selection image. As shown in FIG. 8, recipe-selection list 430 of the recipe-selection image contains selection-assisting information 540. Selection-assisting information 540 contains a plurality of items relating to ingredients or cooking techniques and numerical values relating to each item. Specifically, selection-assisting information 540 can be represented by a regular pentagonal radar chart with five items as vertices.

Selection-assisting information 540 contains item names 541 and graph 542 of the target recipe. Graph 542 is a pentagon connecting the values of the items of the target recipe, which represents the characteristics of the target recipe. In the embodiment, the five items are “Nr. of Cutting Times,” “Cooking Time,” “Nr. of Food Materials,” “Salt Content,” and “Nr. of Heating Times.”

Selection-assisting information 540 contains statistical values, as a comparison object, for each item of the plurality of cooking recipes. Specifically, selection-assisting information 540 contains comparison information 543. Comparison information 543 is indicated by a shaded pentagon area defined by connecting statistical values for the respective items. The kind of shading is not limited. Instead of shading, the area may be painted in a predetermined color. Alternatively, comparison information 543 may be represented only by five line-segments connecting the statistical values for the respective items.

Each of the statistical values is an average value, for each item, of the plurality of cooking recipes. For example, the statistical value is an average value, for each item, of all of the cooking recipes held in cooking recipe DB 110.

The statistical value may be an average value of cooking recipes that are retrieved, by search, from among the cooking recipes held in cooking recipe DB 110. That is, the statistical value may be an average value for each item of all of the cooking recipes contained in recipe-selection list 430. The statistical value may be a median of a plurality of cooking recipes.

Use of a radar chart allows the values for the plurality of items to be visualized to facilitate easy comparison of the characteristics of the plurality of cooking recipes. Comparison information 543 makes possible further ease of comparison of the characteristics of cooking recipes.

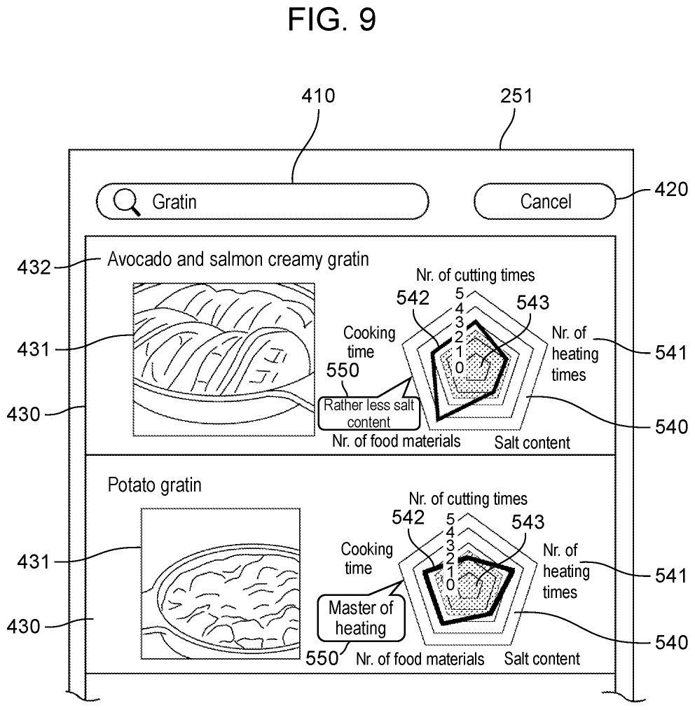

Both the radar chart and the label information may be displayed together. FIG. 9 shows a third example of the recipe-selection image. As shown in FIG. 9, recipe-selection list 430 of the recipe-selection image includes selection-assisting information 540 expressed by a radar chart and selection-assisting information 550 being label information.

For example, a radar chart may be used to represent the items common to a plurality of target recipes, and label information may be used to represent the items that are not common to the plurality of target recipes but have distinctive features. Multiple types of selection-assisting information may be displayed for each cooking recipe. This permits a lot of information to be displayed, thereby assisting the user in selecting the cooking recipe.

Unless the values of items are in balance in the radar chart, the shape of graph 542 distorts. For example, in the cooking recipe “Avocado and Salmon Creamy Gratin” shown in FIG. 8, “Nr. of Food Materials” is much greater than that of comparison information 543. This causes graph 542 to have a pentagon with a sharp vertex that represents the item “Nr. of Food Materials.” In this way, the characteristics of the recipes can be easily compared based on the shape of graph 542.

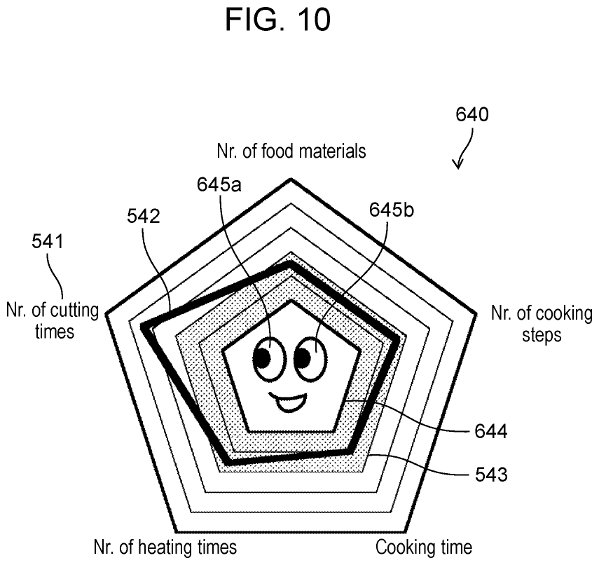

To facilitate ease of recognition of the shape of graph 542, the selection-assisting information may contain a line-of-sight guidance display to guide a user's line of sight. FIG. 10 shows a first example of the selection-assisting information.

As shown in FIG. 10, selection-assisting information 640 contains line-of-sight guidance display 644 in addition to selection-assisting information 540 shown in FIG. 8 or 9. Line-of-sight guidance display 644 is displayed to draw the user's attention to a target item that is at least one of the plurality of items in the radar chart. The target item is an item whose value exceeds a predetermined threshold. In the example shown in FIG. 10, the target item is the item “Nr. of Cutting Times.”

Line-of-sight guidance display 644 includes an illustration display of eyes 645a and 645b of a living thing, with the eyes facing the target item. However, the illustration display is not limited to eyes 645a and 645b.

When a user sees an eye-like shape of a living thing, the user instinctively tends to be aware of the direction in which the shape faces. That is, the user's attention tends to be guided to the item “Nr. of Cutting Times” to which eyes 645a and 645b face. This enables the user to easily recognize that the target recipe has remarkable characteristics in the item “Nr. of Cutting Times” (Specifically, the number of times of cutting is large).

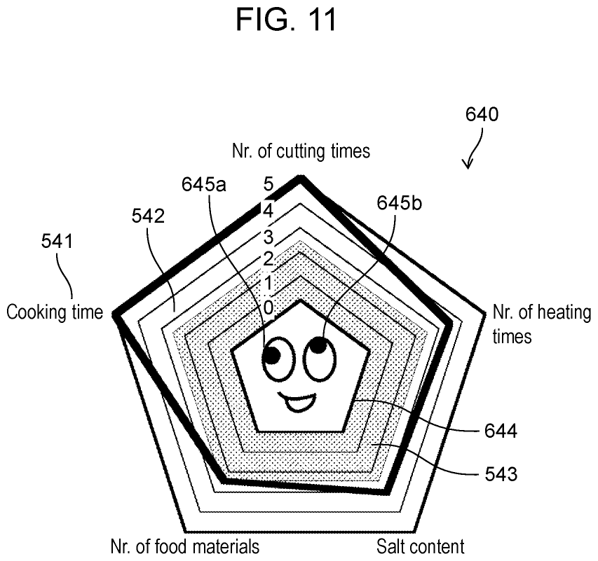

The number of the target items is not limited to one. The item “Nr. of Cutting Times” and the item “Cooking Time” may be the target items. FIG. 11 shows a second example of the selection-assisting information. As shown in FIG. 11, eye 645a faces the item “Cooking Time” while eye 645b faces the item “Nr. of Cutting Times.” In this way, eyes 645a and 645b may be displayed which face respective two or more target items.

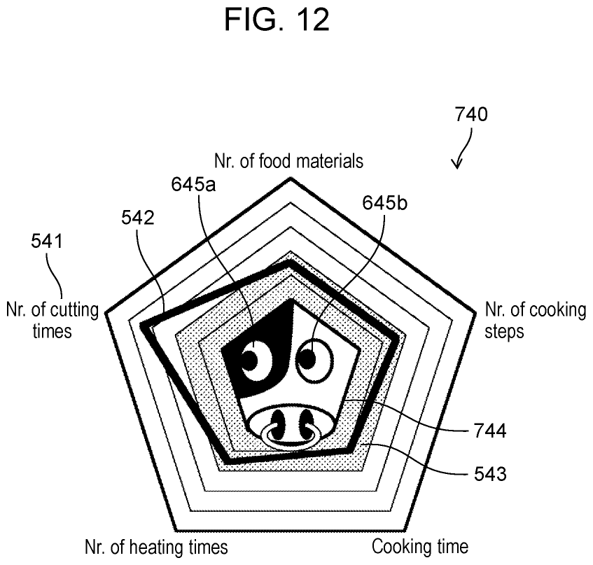

The selection-assisting information may contain an illustration image of a main food material of the target recipe. FIG. 12 shows a third example of the selection-assisting information. As shown in FIG. 12, selection-assisting information 740 contains line-of-sight guidance display 744 instead of line-of-sight guidance display 644 in selection-assisting information 640 shown in FIG. 10.

Line-of-sight guidance display 744 contains an illustration image of a main food material of the target recipe. In the example shown in FIG. 12, line-of-sight guidance display 744 contains an illustration image of a cow's face in order to indicate that the main food material is beef.

In the case where the main food material is fish, line-of-sight guidance display 744 may contain an illustration image of a fish shape. By directing the head of the fish shape toward the direction to a target item, line-of-sight guidance display 744 can draw the user's attention to the item in the direction. The illustration image may be a symbol such as an arrow.

The illustration image indicating the main food material may be separate from the line-of-sight guidance display. That is, the illustration image indicating the main food material may be devoid of the function of drawing the user's attention. For example, a mark such as a cow may be displayed separately from the radar chart.

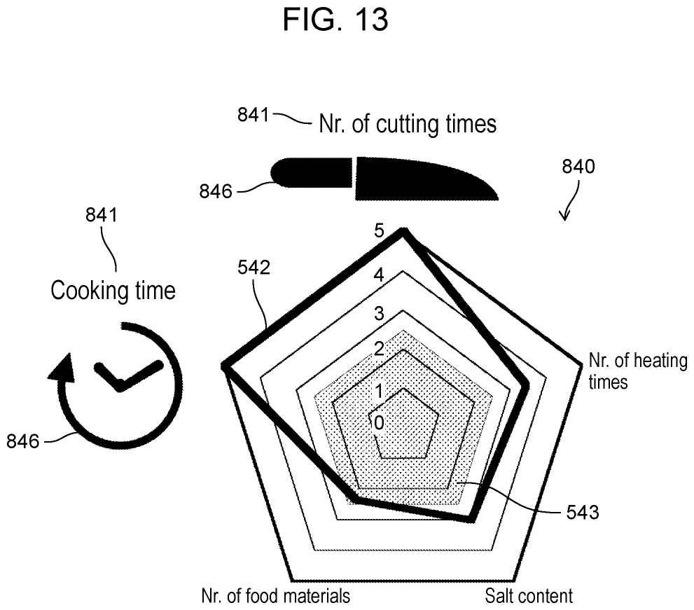

FIG. 13 shows a fourth example of the selection-assisting information. As shown in FIG. 13, selection-assisting information 840 includes characters display-highlighted by either one or both of a character color and size expressing the target item, and icon 846 expressing the target item.

In selection-assisting information 840, the target items are the item “Nr. of Cutting Times” and the term “Cooking Time.” Item name 841 of the item “Nr. of Cutting Times” and item name 841 of the term “Cooking Time” are display-highlighted. Specifically, item names 841 are displayed in larger characters than other items. Item names 841 may be displayed in characters in a different color from that of other characters.

Below item names 841, icons 846 are displayed. Icons 846 are image such as pictograms representing the respective items. Item names 841 may not necessarily be display-highlighted and Icons 846 may not necessarily be displayed.

By performing either one or both of the display-highlighting and the icon-displaying, the target items are visually emphasized to facilitate ease of user's recognition of them. This makes it possible for the user to easily grasp the characteristics of the target recipe.

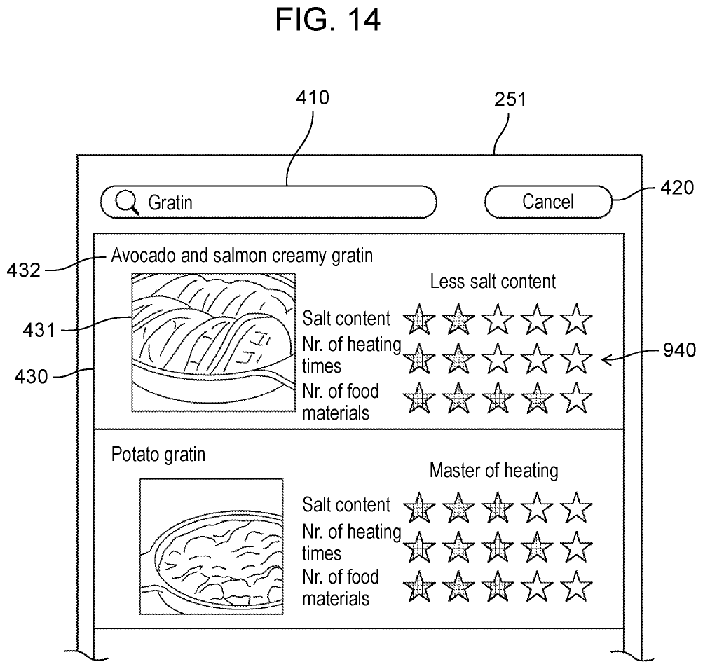

In the examples described so far, the selection-assisting information employs a radar chart. However, the selection-assisting information is not limited to this. FIG. 14 shows a fourth example of the recipe-selection image. As shown in FIG. 14, recipe-selection list 430 of the recipe-selection image contains selection-assisting information 940. Selection-assisting information 940 contains a plurality of items regarding ingredients or cooking techniques, and numerical values of the plurality of respective items.

Specifically, selection-assisting information 940 contains a plurality of marks (stars in this case) for each item. The value of each item is represented by the number of filled stars. The shape of the marks may also be, for example, circles, triangles, squares, etc.

In FIG. 14, both the filled marks and the unfilled marks are displayed. Instead, marks of only one type, i.e., any of filled ones and unfilled ones, may be displayed. That is, the value of each item may be represented by the number of displayed marks regardless of whether they are filled or not.

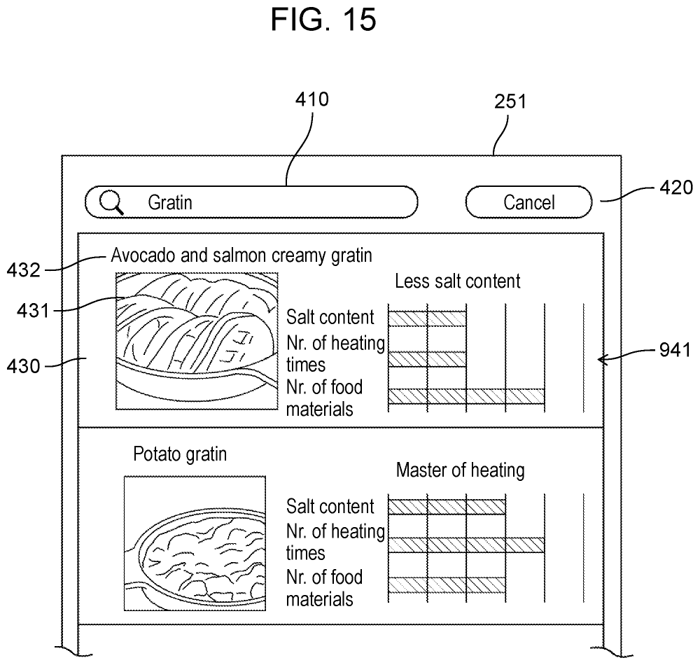

A bar graph may be used instead of the marks. FIG. 15 shows a fifth example of the recipe-selection image. As shown in FIG. 15, recipe-selection list 430 of the recipe-selection image contains selection-assisting information 941. Selection-assisting information 941 contains a plurality of items regarding ingredients or cooking techniques, and numerical values of the plurality of respective items.

Specifically, in selection-assisting information 941, the numerical value regarding each item is represented by a bar graph. By comparing the lengths of bars in the bar graph, the user can easily recognize the characteristics of the cooking recipe.

The types and number of items contained in the selection-assisting information described above can be changed. For example, the types and number of items may be changed in accordance with user's preference. In this case, it is possible to display the items on which the user places importance.

The number and types of items may be different for each piece of selection-assisting information of the cooking recipe. The values of items of the different number or different types may be displayed by a radar chart or bar graph.

### [Supplemental Descriptions]

As described above, a first aspect of the present disclosure is cooking-recipe display system 1 configured to output a plurality of target recipes each of which is a cooking recipe among a plurality of cooking recipes. Cooking-recipe display system 1 includes cooking recipe DB 110, assistance information DB 120, characteristics-detector 230, extractor 240, and outputter 250.

Cooking recipe DB 110 holds the plurality of cooking recipes. Assistance information DB 120 holds selection-assisting information for assisting in selecting the cooking recipe from among the plurality of cooking recipes. Characteristics-detector 230 is configured to detect characteristics of the cooking recipe from a natural language sentence contained in the cooking recipe, the cooking recipe being each of the plurality of target recipes.

Extractor 240 is configured to refer to assistance information DB 120 based on the characteristics of the cooking recipe in the plurality of target recipes to extract the selection-assisting information from the plurality of target recipes. Outputter 250 is configured to output the selection-assisting information regarding the plurality of target recipes, the selection-assisting information being extracted by extractor 240.

Since the selection-assisting information is displayed for each of the plurality of target recipes, a user can select a cooking recipe to be cooked from among the plurality of target recipes while comparing pieces of the selection-assisting information for the plurality of target recipes. In accordance with cooking-recipe display system 1, it is possible to assist in selecting by the user a cooking recipe while reducing the amount of information presented to the user.

Assistance information DB 120 may include ingredient information DB 121 holding the selection-assisting information regarding an ingredient of the cooking recipe, and cooking-technique information DB 122 holding the selection-assisting information regarding a cooking technique of the cooking recipe.

With this configuration, referring to the selection-assisting information regarding the obtaining of ingredients and cooking techniques, the user can select a cooking recipe to be cooked from among the plurality of cooking recipes.

Characteristics-detector 230 may be configured to detect a term as the characteristics of each of the plurality of target recipes, the term being associated with an item selected from the following information group. The information group may include either one or both of a number of the ingredient and a kind of the ingredient, either one or both of a number of cooking actions and a kind of the cooking actions, a number of cooking procedures, cooking time, and either one or both of a number of cooking utensils and a kind of the cooking utensils.

With this configuration, selection-assisting information can be displayed which expresses the specific characteristics associated with each cooking recipe. As a result, it is possible to effectively assist in user's selecting a cooking recipe.

Outputter 250 may include display screen 251. Display screen 251 may display, for each of the plurality of target recipes, both recipe-displaying information selectable by a user and the selection-assisting information, next to each other. By referring to the selection-assisting information, the user can easily compare a plurality of cooking recipes and thus easily select a cooking recipe to be cooked.

The selection-assisting information may contain a plurality of items regarding either ingredients of the cooking recipe or cooking techniques of the cooking recipe, and a numerical value regarding each of the plurality of items. By presenting a large amount of information to the user, it is possible to effectively assist in user's selecting a cooking recipe.

The selection-assisting information may be expressed by either a radar chart or a bar graph. By displaying the selection-assisting information in an easy-to-understand manner for the user, it is possible to effectively assist in user's selecting a cooking recipe.

The kind and number of the items contained the selection-assisting information may be changeable. By changing the type and number of the items in accordance with user's preference, it is possible to effectively assist in user's selecting a cooking recipe.

The selection-assisting information may contain a statistical value regarding the item in the plurality of cooking recipes. This allows average values and the like of other cooking recipes to be displayed as a comparison object, for example.

The selection-assisting information may contain a line-of-sight guidance display for drawing attention of a user to at least one of the target items each of which is the item described above. With this configuration, for example, it is possible to draw user's attention to the item having outstanding characteristics among a plurality of the items, resulting in effective assistance in user's selecting a cooking recipe.

The line-of-sight guidance display may include an illustration display containing an eye of a living thing, the eye facing the at least one target item described above. With this configuration, it is possible to draw user's attention toward an intended direction, thereby easily conveying the characteristics of a target recipe to the user.

The line-of-sight guidance display may include a character display-highlighted by either one or both of a color expressing the target item and a size expressing the target item, and an icon expressing the target item. This makes it possible to effectively assist in user's selecting a cooking recipe.

The selection-assisting information may contain an illustration image of a main food material of each of the plurality of target recipes. This makes it possible for the user to easily grasp the main food material of the cooking recipe.

Cooking-recipe display system 1 may further includes input part 210 and recipe-selection part 220. Input part 210 may receive an input of a search term regarding cooking. Recipe-selection part 220 may refer to cooking recipe DB 110 based on the search term to select the plurality of target recipes. This makes it possible to effectively assist in selecting a cooking recipe from a plurality of cooking recipe, by using the search term input by a user.

A second aspect of the present disclosure is a cooking-recipe display device configured to output a plurality of target recipes each of which is a cooking recipe among a plurality of cooking recipes. The cooking-recipe display device includes a detector, an extractor, and an outputter.

The detector is configured to detect characteristics of the cooking recipe from a natural language sentence contained in the cooking recipe, the cooking recipe being each of the plurality of target recipes.

The extractor is configured to refer to selection-assisting information for assisting in selecting the cooking recipe from among the plurality of cooking recipes, based on the characteristics of the cooking recipe. Thereby, the extractor extracts the selection-assisting information from the plurality of target recipes.

The outputter is configured to output the thus-extracted selection-assisting information regarding the plurality of target recipes.

A third aspect of the present disclosure is a cooking-recipe display method of outputting a plurality of target recipes each of which is a cooking recipe among a plurality of cooking recipes. The cooking-recipe display method includes the following steps.

The steps include detecting characteristics of the cooking recipe from a natural language sentence contained in the cooking recipe, the cooking recipe being each of the plurality of target recipes.

The steps include referring to selection-assisting information for assisting in selecting the cooking recipe from among the plurality of cooking recipes, based on the characteristics of the cooking recipe, thereby extracting the selection-assisting information from the plurality of target recipes.

The steps include outputting the selection-assisting information extracted regarding the plurality of target recipes.

A fourth aspect of the present disclosure is a program configured to cause a computer to execute the cooking-recipe display method described above, or a recording medium storing the program.

### OTHER EMBODIMENTS

Assistance information DB 120 may not necessarily include any one of ingredient information DB 121 and cooking-technique information DB 122. That is, cooking-recipe display system 1 may output only one of selection-assisting information regarding ingredients and selection-assisting information regarding cooking techniques.

Cooking-recipe display system 1 may include a household electric appliance that is communicatively coupled, via a network, to at least one of server device 100 and information-processing terminal 200. The household electric appliance is, for example, a microwave oven, cooking appliance such as an IH cooker (IH hob), or refrigerator.

For example, at least one of server device 100 and information-processing terminal 200 transmits a command for executing the procedures of a cooking recipe to the household electric appliance. The household electric appliance receives the transmitted command, and performs the processing according to the received command. In the case where the household electric appliance is a refrigerator, the refrigerator may manage information regarding kinds and storage periods of food materials stored therein, and may transmit the information to server device 100.

The recipe-selection image is not limited to the examples shown in the embodiments described above. The content and layout of the recipe-selection image may be changed as appropriate.

The database and the table are not limited to the examples shown in the embodiments described above. The items, contents, etc. of the information held in the database and table may be changed as appropriate.

In the above embodiment, some of the processing performed by a certain processing unit may be performed by another processing unit. The order of a plurality of processes may be changed, and a plurality of processes may be performed concurrently.

The constituent elements included in the cooking-recipe display system may be each composed of a single device or may be each composed of a plurality of devices. The cooking-recipe display system according to the above embodiments may be implemented by centralized processing or may be implemented by distributed processing.

In the above embodiments, all or part of the constituent elements such as a controller may be composed of dedicated hardware, or may be composed of a combination of a software program suitable for each constituent element and a general-purpose processor.

### INDUSTRIAL APPLICABILITY

The cooking-recipe display system according to the present disclosure is applicable to household electric appliances such as cooking devices and refrigerators.

### REFERENCE MARKS IN THE DRAWINGS

1 cooking-recipe display system
100 server device
110 cooking recipe DB
111 ingredient table
112 procedure table
120 assistance information DB
121 ingredient information DB
122 cooking-technique information DB
200 information-processing terminal
210 input part
220 recipe-selection part
230 characteristics-detector
240 extractor
250 outputter
251 display screen
301, 302, 311, 312 frame
410 search window
420 cancel button
430 recipe-selection list
431 dish image
432 dish name
440, 540, 550, 640, 740, 840, 940, 941 selection-assisting information
541, 841 item name
542 graph
543 comparison information
644, 744 line-of-sight guidance display
645a, 645b eye
846 icon

1. A cooking-recipe display system configured to output a plurality of target recipes each of which is a cooking recipe among a plurality of cooking recipes, the cooking-recipe display system, comprising:
a cooking recipe database holding the plurality of cooking recipes;
an assistance information database holding selection-assisting information for assisting in selecting the cooking recipe from among the plurality of cooking recipes;
a detector configured to detect characteristics of the cooking recipe from a natural language sentence contained in the cooking recipe in the plurality of target recipes;
an extractor configured to refer to the assistance information database based on the characteristics of the cooking recipe in the plurality of target recipes to extract the selection-assisting information from the plurality of target recipes; and
an outputter configured to output the selection-assisting information regarding the plurality of target recipes, the selection-assisting information being extracted by the extractor.

2. The cooking-recipe display system according to claim 1, wherein the assistance information database includes
an ingredient information database holding the selection-assisting information regarding an ingredient of the cooking recipe, and
a cooking-technique information database holding the selection-assisting information regarding a cooking technique of the cooking recipe.

3. The cooking-recipe display system according to claim 2, wherein the detector is configured to detect a term as the characteristics of each of the plurality of target recipes, the term being associated with an item selected from the group consisting of
either one or both of a number of the ingredient and a kind of the ingredient,
either one or both of a number of cooking actions and a kind of the cooking actions,
a number of cooking procedures,
cooking time, and
either one or both of a number of cooking utensils and a kind of the cooking utensils.

4. The cooking-recipe display system according to claim 1,
wherein the outputter including a display, and
wherein the display displays, for each of the plurality of target recipes, both recipe-displaying information selectable by a user and the selection-assisting information, next to each other.

5. The cooking-recipe display system according to claim 4, wherein the selection-assisting information contains
an item regarding either an ingredient of the cooking recipe or a cooking technique of the cooking recipe, and
a numerical value regarding the item.

6. The cooking-recipe display system according to claim 5, wherein the selection-assisting information is expressed by either a radar chart or a bar graph.

7. The cooking-recipe display system according to claim 5, wherein a kind of the item and a number of the item are changeable, the item being contained the selection-assisting information.

8. The cooking-recipe display system according to claim 5, wherein the selection-assisting information contains a statistical value regarding the item in the plurality of cooking recipes.

9. The cooking-recipe display system according to claim 5, wherein the selection-assisting information contains
a line-of-sight guidance display for drawing attention of a user to at least one target item, the at least one target item comprising a plurality of target items each of which equals the item.

10. The cooking-recipe display system according to claim 9, wherein the line-of-sight guidance display includes
an illustration display containing an eye of a living thing, the eye facing the at least one target item.

11. The cooking-recipe display system according to claim 9, wherein the line-of-sight guidance display includes
a character display-highlighted by either one or both of a color expressing the target item and a size expressing the target item, and
an icon expressing the target item.

12. The cooking-recipe display system according to claim 1, wherein the selection-assisting information contains
an illustration image of a main food material of each of the plurality of target recipes.

13. The cooking-recipe display system according to claim 1, further comprising
an input part configured to receive an input of a search term, and
a selection part configured to refer to the cooking recipe database based on the search term to select the plurality of target recipes.

14. A cooking-recipe display device configured to output a plurality of target recipes each of which is a cooking recipe among a plurality of cooking recipes, the cooking-recipe display device, comprising:
a detector configured to detect characteristics of the cooking recipe from a natural language sentence contained in the cooking recipe, the cooking recipe being each of the plurality of target recipes;
an extractor configured to refer to the selection-assisting information based on the characteristics of the cooking recipe to extract, from the plurality of target recipes, selection-assisting information for assisting in selecting the cooking recipe from among the plurality of cooking recipes; and
an outputter configured to output the selection-assisting information regarding the plurality of target recipes, the selection-assisting information being extracted by the extractor.

15. A cooking-recipe display method of outputting a plurality of target recipes each of which is a cooking recipe among a plurality of cooking recipes, the cooking-recipe display method, comprising the steps of:
detecting characteristics of the cooking recipe from a natural language sentence contained in the cooking recipe, the cooking recipe being each of the plurality of target recipes;
referring to the selection-assisting information based on the characteristics of the cooking recipe to extract, from the plurality of target recipes, selection-assisting information for assisting in selecting the cooking recipe from among the plurality of cooking recipes; and
outputting the selection-assisting information extracted regarding the plurality of target recipes.

16. A program configured to cause a computer to execute the cooking-recipe display method according to claim 15.
